(19) United States
(12) Patent Application Publication
(10) Pub. No.: US 2023/0146482 A1
(43) Pub. Date: May 11, 2023

(54) FLUSHING TIMING ADJUSTMENT METHOD AND INKJET RECORDING DEVICE

(71) Applicant: KYOCERA Document Solutions Inc, Osaka (JP)

(72) Inventor: Yuichiro KUROKAWA, Osaka-shi (JP)

(21) Appl. No.: 17/918,642

(22) PCT Filed: Apr. 16, 2021
(86) PCT No.: PCT/JP2021/015703

§ 371 Date: Oct. 13, 2022

(30) Foreign Application Priority Data
Apr. 21, 2020 (JP) 2020-075586
Feb. 12, 2021 (JP) 2021-020462

(51) Int. Cl. B41J 2/165

(52) U.S. Cl. CPC B41J 2/16517

(57) ABSTRACT

A first chart is recorded on a recording medium by discharging ink from predetermined nozzles of a recording head at a plurality of discharge timings set in advance with the detection time point of the recording medium by a recording medium detection sensor as a reference time point, and a second chart is recorded alongside the first chart on the recording medium by discharging the ink from other nozzles of the recording head at a plurality of discharge timings set in advance with the detection time point of the recording medium by the opening detection sensor as a reference time point. A flushing timing, which is set with the detection time point of the opening by the opening detection sensor as the reference time point, is adjusted in accordance with an input of an instruction following the recording of the first chart and the second chart on the recording medium.

### TECHNICAL FIELD

The present invention relates to a flushing timing adjustment method of an inkjet recording device and an inkjet recording device therefor.

### BACKGROUND ART

Use of quick-drying ink in inkjet printers and other inkjet recording devices tends to clog nozzles of recording heads easily due to thickening of ink by drying. Thickened ink needs to be discharged before printing on the paper. An ink discharging operation that does not contribute to image formation on the paper is also referred to herein as flushing (idle discharge).

Conventional flushing techniques are disclosed in, for example, Patent Literature 1 to 3. In Patent Literature 1, the flushing is performed by discharging ink from the recording heads between sheets of paper (so-called “between the papers”) supplied to a conveyance belt and causing the ink to pass through openings of the conveyance belt. An opening detection sensor detects the positions of the openings in the conveyance belt, and the discharge of ink during flushing is controlled in accordance with the detection result.

Patent Literature 2 discloses a technique to correct the ink discharge timing relative to the openings by taking into account the effect of variations in the pitch of the openings in the paper conveyance direction due to, for example, a perimeter tolerance of the conveyance belt.

For example, when the paper is placed on the conveyance belt overlapping the openings, paper deflection occurs and a distance (gap) between the recording head and the paper becomes uneven. This may degrade the quality of the image to be recorded on the paper. In Patent Literature 3, the paper is supplied to the conveyance belt so as not to overlap the openings, thus suppressing the deterioration in quality of the recorded image due to the paper deflection.

### CITATION LIST

### Patent Literature

PTL 1: Japanese Unexamined Patent Publication No. 2001-113690
PTL 2: Japanese Unexamined Patent Publication No. 2012-45867
PTL 3: Japanese Unexamined Patent Publication No. 2006-21399

### SUMMARY OF THE INVENTION

### Problems to be Solved by the Invention

An opening detection sensor has a detection tolerance (variations in detection accuracy) and an installation position tolerance (variations in installation position). Even when a device is designed using a center value of each tolerance, accumulating the tolerances should increase the variations in ink discharge timing during flushing (flushing timing) between devices. To facilitate handling of such variations in the flushing timing, it may be possible, for example, to enlarge the openings of the conveyance belt. However, the enlarged openings may lead to a decrease of the strength of the conveyance belt and eventually break the conveyance belt. In addition, the enlarged openings may also lead to a decrease in print quality due to the change of the gap caused by the deflection of the paper that overlaps the openings, as described in Patent Literature 3. For this reason, it is preferable to form the openings as small as possible.

Therefore, without forming the opening larger than necessary to reduce the effect of the tolerance of the opening detection sensor, it is necessary to properly adjust the flushing timing for each device such that the ink discharged from the recording heads during flushing can accurately pass through the openings. Such flushing timing adjustment, however, has not been proposed in the past.

In view of the above problems, it is an object of the present invention to provide a flushing timing adjustment method capable of properly adjusting the flushing timing and executing the flushing accurately, without unnecessarily enlarging the openings to decrease the effect of the tolerance of the opening detection sensor, and also provide an ink jet recording device capable of executing such flushing timing adjustment.

### Means for Solving the Problem

A flushing timing adjustment method according to an aspect of the present invention is a flushing timing adjustment method of an inkjet recording device for adjusting a flushing timing which is an ink discharge timing for flushing to discharge ink from a recording head toward openings of an endless conveyance belt. The adjustment method includes detecting a recording medium supplied from a recording medium supply portion to the conveyance belt by a recording medium detection sensor, detecting the recording medium conveyed by the conveyance belt by an opening detection sensor that detects the openings that move by running of the conveyance belt, recording a first chart on the recording medium by discharging ink from a predetermined nozzle of the recording head at a plurality of discharge timings set in advance using a detection time point at which the recording medium is detected by the recording medium detection sensor as a reference time point, and recording a second chart on the recording medium alongside the first chart by discharging ink from another nozzle of the recording head at a plurality of discharge timings set in advance using a detection time point at which the recording medium is detected by the opening detection sensor as a reference time point, and adjusting the flushing timing in accordance with the an input of an instruction following the recording of the first chart and the second chart are recorded on the recording medium, the flushing timing being set using the detection time point at which the opening is detected by the opening detection sensor as a reference time point.

An inkjet recording device according to another aspect of the present invention includes a recording head having a plurality of nozzles for discharging ink, an endless conveyance belt that conveys a recording medium and has openings at a plurality of locations in the conveyance direction of the recording medium, the plurality of openings allowing ink to pass through when the recording head executes flushing for discharging ink at timing different from timing that contributes to image formation, a recording medium supply portion that supplies the recording medium to the conveyance belt, a recording medium detection sensor that detects the recording medium supplied from the recording medium supply portion to the conveyance belt, an opening detection sensor that detects the openings that move by running of the conveyance belt, and also detects the recording medium on the conveyance belt, and a discharge control portion that controls discharging of the ink in the recording head. The discharge control portion causes a first chart to be recorded on the recording medium by discharging ink from a predetermined nozzle of the recording head at a plurality of discharge timings set in advance using a detection time point at which the recording medium is detected by the recording medium detection sensor as a reference time point, and causes a second chart to be recorded on the recording medium alongside the first chart by discharging ink from another nozzle of the recording head at a plurality of discharge timings set in advance using a detection time point at which the recording medium is detected by the opening detection sensor as a reference time point.

### Effect of the Invention

The flushing timing, which is set using the detection time point of the openings by the opening detection sensor as the reference time point, is adjusted in accordance with the input of the instruction following the recording of the first chart and the second chart on the recording medium. When the flushing is performed during the use of the device on the user side, the ink can be discharged from the recording heads at the pre-adjusted flushing timing and passes through the openings of the conveyance belt, even though the opening detection sensor has the tolerance (detection tolerance, installation position tolerance). Therefore, it is possible to perform the flushing accurately without enlarging the openings unnecessarily to reduce the effect of the tolerance. Furthermore, the inkjet recording device capable of such flushing timing adjustment can be implemented.

### BRIEF DESCRIPTION OF THE DRAWINGS

FIG. 1 is an explanatory view schematically illustrating a structure of a printer as an inkjet recording device according to an embodiment of the present invention.

FIG. 2 is a plan view of a recording portion provided in the printer.

FIG. 3 is en explanatory view schematically illustrating a structure around a paper conveyance path from a paper-feed cassette to a second conveyance unit via a first conveyance unit in the printer.

FIG. 4 is a block diagram illustrating a hardware structure of a major part of the printer.

FIG. 5 is a plan view illustrating an example of a structure of a first conveyance belt included in the first conveyance unit.

FIG. 6 is an explanatory view schematically illustrating an example of a pattern of opening groups for flushing and the paper placed on the first conveyance belt according to the pattern when the first conveyance belt of FIG. 5 is used.

FIG. 7 is an explanatory view schematically illustrating another example of the pattern and the paper placed on the first conveyance belt according to the pattern.

FIG. 8 is an explanatory view schematically illustrating still another example of the pattern and the paper placed on the first conveyance belt according to the pattern.

FIG. 9 is an explanatory view schematically illustrating still another example of the pattern and the paper placed on the first conveyance belt according to the pattern.

FIG. 10 is an explanatory view schematically illustrating a light amount distribution of reflected light when an object is irradiated with light.

FIG. 11 is a cross-sectional view illustrating a schematic structure of an opening detection sensor provided in the printer.

FIG. 12 is an explanatory view schematically illustrating variations in signals output from the opening detection sensor.

FIG. 13 is a flowchart illustrating a flow of operation according to a flushing timing adjustment method.

FIG. 14 is a timing chart illustrating examples of output signals from various sensors and various timings when paper is supplied to the first conveyance belt.

FIG. 15 is an explanatory view schematically illustrating an example of a first chart and a second chart recorded on paper when the adjustment method is implemented.

FIG. 16 is an explanatory view schematically illustrating a state in which a positional discrepancy has occurred between the first chart and the second chart in the structure illustrate in FIG. 15.

FIG. 17 is an explanatory view schematically illustrating another example of the first chart and the second chart.

FIG. 18 is an explanatory view schematically illustrating a state in which a positional discrepancy has occurred between the first chart and the second chart in the structure illustrated in FIG. 17.

FIG. 19 is a timing chart at least illustrating a flushing executable timing for each opening of two opening rows that belong to each opening group of the first conveyance belt.

### MODE FOR CARRYING OUT THE INVENTION

### 1. Structure of Inkjet Recording Device

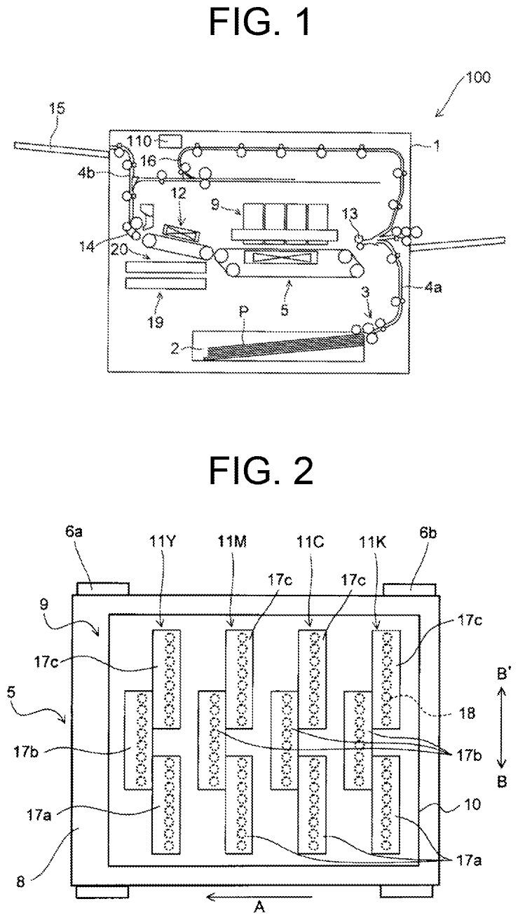

An embodiment of the present invention will be described below with reference to the accompanying drawings. FIG. 1 is an explanatory view schematically illustrating the structure of a printer 100 as an inkjet recording device. The printer 100 includes a paper-feed cassette 2 as a paper storage portion. The paper-feed cassette 2 is disposed in a lower portion in a printer body 1. Paper P is stored in the paper-feed cassette 2 as an example of a recording medium.

A paper feeder 3 is disposed on a downstream side of the paper-feed cassette 2 in a paper conveyance direction, that is, on an upper right side of the paper-feed cassette 2 in FIG. 1. The paper feeder 3 separates and feeds paper P one sheet at a time toward the upper right side of the paper-feed cassette 2.

The printer 100 includes a first paper conveyance path 4a therein. The first paper conveyance path 4a is located on the upper right side of the paper-feed cassette 2 in the paper-feed direction. The paper P, which is fed out of the paper-feed cassette 2, is conveyed perpendicularly upward along the first paper conveyance path 4a on a side surface of the printer body 1.

A registration roller pair 13 is provided at a downstream end of the first paper conveyance path 4a in the paper conveyance direction. In addition, a first conveyance unit 5 and a recording portion 9 are disposed in the immediate vicinity on a downstream side of the registration roller pair 13 in the paper conveyance direction. The paper P is fed out of the paper-feed cassette 2 and reaches the registration roller pair 13 through the first paper conveyance path 4a. The registration roller pair 13 measures timing for an ink discharge operation executed by the recording portion 9 while correcting diagonal feed of the paper P, and feeds the paper P toward the first conveyance unit 5 (particularly to a first conveyance belt 8 which will be described later). That is, the registration roller pair 13 is a recording medium supply portion that supplies the paper P onto the first conveyance belt 8.

The paper P fed to the first conveyance unit 5 by the registration roller pair 13 is conveyed by the first conveyance belt 8 to a position facing the recording portion 9 (in particular, recording heads 17a to 17c, which will be described below). Ink is discharged onto the paper P from the recording portion 9 to record an image on the paper P. The ink discharge in the recording portion 9 is controlled by a controller 110 in the printer 100.

In the paper conveyance direction, a second conveyance unit 12 is disposed on a downstream side (left side in FIG. 1) of the first conveyance unit 5. The paper P, on which the image is recorded by the recording portion 9, is conveyed to the second conveyance unit 12. The ink discharged onto the surface of the paper P is dried while the paper P passes through the second conveyance unit 12.

In the paper conveyance direction, a de-curler portion 14 is provided on the downstream side of the second conveyance unit 12 and near the left side of the printer body 1. The paper P, on which the ink has been dried by the second conveying portion 12, is conveyed to the de-curler portion 14 to uncurl the curling of the paper P.

In the paper conveyance direction, a second paper conveyance path 4b is provided on the downstream side (upper side in FIG. 1) of the de-curler portion 14. In a case where double-sided recording is not performed, the paper P, which has passed through the de-curler portion 14, passes through the second paper conveyance path 4b and is discharged to a paper discharge tray 15 that is provided on the outside of a left surface of the printer 100.

A reverse conveyance path 16 for the double-sided recording is provided at an upper portion of the printer body 1 and above the recording portion 9 and the second conveyance unit 12. In a case where the double-sided recording is performed, the paper P, on which recording is completed on one surface (first surface) thereof and which has passed through the second conveyance unit 12 and the de-curler portion 14, is conveyed to the reverse conveyance path 16 through the second paper conveyance path 4b.

The conveyance direction of the paper P, which has been conveyed to the reverse conveyance path 16, is switched for subsequent recording on the other surface (second surface) of the paper P. Then, the paper P passes through the upper portion of the printer body 1 to proceed rightward, and is conveyed to the first conveyance unit 5 again via the registration roller pair 13 with the second surface thereof faces upward. In the first conveyance unit 5, the paper P is conveyed to the position facing the recording portion 9, and the ink is discharged from the recording portion 9 to the second surface to record the image thereon. After the double-sided recording is performed, the paper P is discharged to the paper discharge tray 15 through the second conveyance unit 12, the de-curler portion 14, and the second paper conveyance path 4b in this order.

A maintenance unit 19 and a cap unit 20 are provided below the second conveyance unit 12. The maintenance unit 19 moves horizontally below the recording portion 9 in execution of purging, wipes the ink pushed out of ink discharge port of the recording head, and collects the wiped ink. Purging refers to an operation to forcibly push out the ink from the ink discharge port of the recording head in order to discharge thickened ink, a foreign substance, or air bubbles in the ink discharge ports. The cap unit 20 moves horizontally toward the position below the recording portion 9 when capping the ink discharge surface of the recording head, then farther moves upward and is mounted on a lower surface of the recording head.

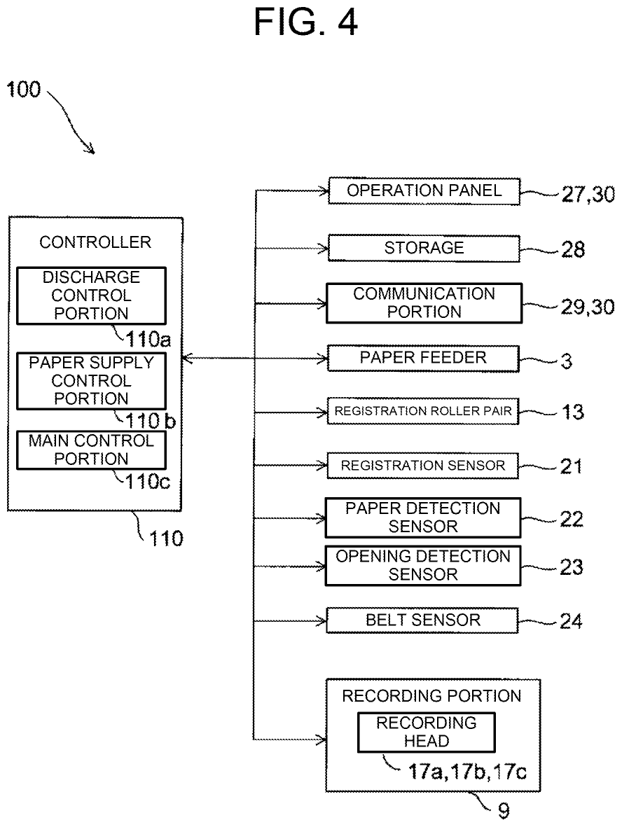

FIG. 2 is a plan view of the recording portion 9. The recording portion 9 includes a head housing 10 and line heads 11Y, 11M, 11C, and 11K. The line heads 11Y to 11K are held by the head housing 10 at a height capable of forming a predetermined distance (for example, 1 mm) from the conveyance surface of the endless first conveyance belt 8 stretching between a plurality of rollers including a drive roller 6a, a driven roller 6b, and tension rollers 7a, 7b. The drive roller 6a causes the first conveyance belt 8 to move in the conveyance direction of the paper P (arrow A direction). This drive roller 6a is driven by the main control portion 110c of the controller 110 (see FIG. 4). The plurality of rollers are arranged in an order of the tension roller 7a, the tension roller 7b, the driven roller 6b, and the drive roller 6a along a moving direction of the first conveyance belt 8.

The line heads 11Y to 11K each have a plurality of (three in this case) recording heads 17a to 17c. The recording heads 17a to 17c are arranged in a staggered manner along a paper width direction (arrow BB′ direction) perpendicular to the paper conveyance direction (the arrow A direction). Each of the recording heads 17a to 17c has a plurality of ink discharge ports 18 (nozzles). The ink discharge ports 18 are arranged at equally-spaced intervals in a width direction of the recording head, that is, the paper width direction (arrow BB′ direction). The inks of yellow (Y), magenta (M), cyan (C), and black (K) colors are discharged respectively onto the paper P that is conveyed on the first conveyance belt 8 from each of the line heads 11Y to 11K via the ink discharge ports 18 of the recording heads 17a to 17c.

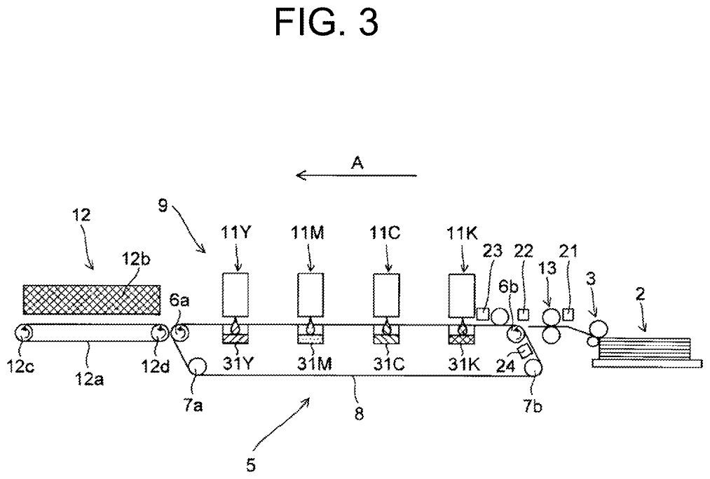

FIG. 3 schematically illustrates the structure around the conveyance path of the paper P from the paper-feed cassette 2 to the second conveyance unit 12 via the first conveyance unit 5. FIG. 4 is a block diagram illustrating a hardware structure of the major part of the printer 100. In addition to the above structure, the printer 100 further includes a registration sensor 21, a paper detection sensor 22, an opening detection sensor 23, and a belt sensor 24.

The registration sensor 21 detects the paper P that is conveyed from the paper-feed cassette 2 by the paper feeder 3 and is fed to the registration roller pair 13. The registration sensor 21 is located on the upstream side of the registration roller pair 13 in a paper supply direction of the paper P. A paper supply control portion 110b, which will be described later, of the controller 110, can control a rotation start timing of the registration roller pair 13 in accordance with the detection result of the registration sensor 21. For example, the paper supply control portion 110b can control the paper supply timing of the paper P to the first conveyance belt 8 after skew correction by the registration roller pair 13 in accordance with the detection result of the registration sensor 21.

The paper detection sensor 22 is a recording medium detection sensor that detects the passage (timing) of a leading edge of the paper P fed from the registration roller pair 13 to the first conveyance belt 8. The paper detection sensor 22 is located on the upstream side of the opening detection sensor 23 in the paper conveyance direction. In accordance with the detection result of the paper P by the paper detection sensor 22, the discharge control portion 110a can control the ink discharge timing for the paper P that reaches the position facing line heads 11Y to 11K (recording heads 17a to 17c) by the first conveyance belt 8.

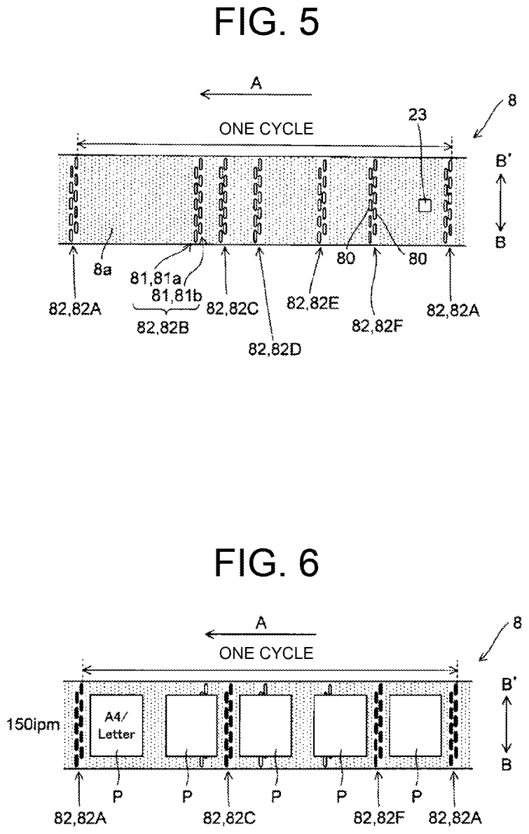

The opening detection sensor 23 detects openings 80 (see FIG. 5), which will be described later, formed in the first conveyance belt 8. The opening detection sensor 23 is located on the upstream side of the recording portion 9 and on the downstream side of the paper detection sensor 22 in the paper conveyance direction (running direction of the first conveyance belt 8). The discharge control portion 110a can control the recording heads 17a to 17c in accordance with the detection result of the openings 80 by the opening detection sensor 23, and discharge the ink at a predetermined timing during flushing which will be described later.

The belt sensor 24 detects the position of an opening group 82 (openings 80) which is used as a reference during conveyance of the paper among a plurality of opening groups 82 of the first conveyance belt 8. For example, a marker may be attached on the first conveyance belt 8 at a position corresponding to the reference opening group 82, so that the belt sensor 24 can detect the reference opening group 82 by detecting the marker.

The belt sensor 24 is located on the upstream side of the driven roller 6b on which the first conveyance belt 8 stretches in the paper conveyance direction (running direction of the first conveyance belt 8). Therefore, the belt sensor 24 may be located between the driven roller 6b and the other roller 7b, or between the rollers 7a and 7b. The driven roller 6b is located on the upstream side of the recording portion 9 in the running direction of the first conveyance belt 8. The paper supply control portion 110b can control the registration roller pair 13 such that the paper P is supplied to the first conveyance belt 8 at a predetermined timing in accordance with the detection result of the opening group 82 by the belt sensor 24.

The paper detection sensor 22, the opening detection sensor 23, and the belt sensor 24, which have been described above, can be provided as transmissive or reflective optical sensors, contact image (CIS) sensors, or the like. In particular, the opening detection sensor 23 is desirably provided as the optical sensor capable of detecting both regularly reflected light and the diffusely reflected light, the reasons for which will be described later.

Furthermore, the printer 100 may include a meandering detection sensor that detects meandering of the first conveyance belt 8 and correct the meandering of the first conveyance belt 8 in accordance with the detection result.

The printer 100 further includes an operation panel 27, a storage 28, and a communication portion 29.

The operation panel 27 is a control panel for accepting various types of input for setting. For example, the user can operate the operation panel 27 to enter information on the size of the paper P to be set in the paper-feed cassette 2, that is, the information on the size of the paper P to be conveyed by the first conveyance belt 8. The user can also operate the operation panel 27 to enter the number of sheets of the paper P to be printed or instruct to start print jobs.

The storage 28 is a memory that stores an operating program of the controller 110 and various types of information, and is configured to include a read only memory (ROM), a random access memory (RAM), a non-volatile memory, or the like. The storage 28 stores the information set using the operation panel 27 (for example, the information on the size of the paper P). The storage 28 also stores information on the position of each opening 80 of the first conveyance belt 8 and a pattern of the openings 80 through which ink is passed during the flushing which will be described later.

The communication portion 29 is a communication interface used to exchange information with an external device (for example, a personal computer (PC)). For example, when the user operates the PC to send a print command and image data to the printer 100, the image data and the print command are entered to the printer 100 via the communication portion 29. In the printer 100, the discharge control portion 110a controls the recording heads 17a to 17c in accordance with the image data to discharge ink to record the image on the paper P.

In view of the above, the operation panel 27 and communication portion 29 can also be regarded as functioning as an input accepting portion 30 that accepts input of various types of information.

The printer 100 of the present embodiment also includes the controller 110. The controller 110 is composed of, for example, a central processing unit (CPU), and includes the discharge control portion 110a, the paper supply control portion 110b, and the main control portion 110c. The discharge control portion 110a controls the discharge of ink from the recording heads 17a to 17c. The paper supply control portion 110b is a recording medium supply control portion that controls the registration roller pair 13 as the recording medium supply portion in accordance with the detection result of the opening group 82 by the belt sensor 24, thus controlling the supply of the paper P to the registration roller pair 13. The main control portion 110c controls the operation of individual parts in the printer 100. The discharge control portion 110a, the paper supply control portion 110b, and the main control portion 110c may further function as an arithmetic portion that performs necessary calculations and as a timekeeping portion that measures time.

Furthermore, as illustrated in FIG. 3, the printer 100 includes ink receiving portions 31Y, 31M, 31C, and 31K on an inner circumferential surface side of the first conveyance belt 8. The ink receiving portions 31Y to 31K receive and collect the ink discharged from the recording heads 17a to 17c and passed through the openings 80 of the first conveyance belt 8, when the recording heads 17a to 17c executes the flushing. Accordingly, the ink receiving portions 31Y to 31K are disposed at positions facing the recording heads 17a to 17c of the line heads 11Y to 11K via the first conveyance belt 8. The ink collected by the ink receiving portions 31Y to 31K is sent to a waste ink tank, for example, or may be reused without discarding.

Here, the flushing means the discharge of ink from the ink discharge ports 18 at timing different from timing that contributes to the image formation (image recording) on the paper P for the purpose of reducing or preventing clogging of the ink discharge ports 18 caused by drying of the ink. The discharge control portion 110a controls the execution of flushing in the recording heads 17a to 17c.

The above-described second conveyance unit 12 includes a second conveyance belt 12a and a dryer 12b. The second conveyance belt 12a stretches over two drive rollers 12c and a driven roller 12d. The paper P, which is conveyed by the first conveyance unit 5, and on which the image is recorded by the ink discharge by the recording portion 9, is conveyed by the second conveyance belt 12a, dried by the dryer 12b during the conveyance, and is then conveyed to the de-curler portion 14.

### 2. Details of First Conveyance Belt

### 2-1. Example Structure of First Conveyance Belt

Next, the first conveyance belt 8 in the first conveyance unit 5 is described in detail below. FIG. 5 is a plan view illustrating an example of the structure of the first conveyance belt 8. The present embodiment adopts a negative-pressure suction method for suctioning and conveying the paper P onto the first conveyance belt 8 by negative-pressure suction. Thus, the first conveyance belt 8 includes innumerable suction holes 8a to allow the suction air generated by the negative-pressure suction passes through.

The first conveyance belt 8 also includes the opening groups 82. The opening groups 82 is a group of the openings 80 to allow the ink discharged from the nozzles (ink discharge ports 18) of the recording heads 17a to 17c to pass through during flushing. An opening area of one opening 80 is larger than an opening area of one suction hole 8a. The first conveyance belt 8 includes a plurality of opening groups 82 in one cycle of conveying the paper P in the conveyance direction of the paper P (direction A), and six group are provided in the present embodiment. One cycle means a period in which the first conveyance belt 8 makes one round. To distinguish the opening groups 82 from each other, the six opening groups 82 are referred to as opening groups 82A to 82F from the downstream side in the direction A. The suction holes 8a are located between adjacent opening groups 82 in the direction A. That is, in the first conveyance belt 8, no suction holes 8a are formed in an area overlapping the opening groups 82 (around the openings 80).

In one cycle of the first conveyance belt 8, the opening groups 82 are irregularly located in the direction A. That is, in the direction A, a distance between adjacent opening groups 82 is not constant but varies. At this time, the maximum distance between the two adjacent opening groups 82 in the direction A (for example, a distance between the opening group 82A and the opening group 82B in FIG. 5) is longer than a length of the paper P in the direction A at the time when the paper P in the minimum printable size (for example, the paper P of A4 size (landscape)) is placed on the first conveyance belt 8.

Each opening group 82 includes opening rows 81. Each opening row 81 is formed by arranging the plurality of openings 80 in the belt width direction (paper width direction, direction BB′) perpendicular to the direction A. One opening group 82 includes at least one opening row 81 in the direction A, and two opening rows 81 are provided in the present embodiment. To distinguish the two opening rows 81 from each other, it is assumed that one of them is an opening row 81a, and the other is an opening row 81b.

In one opening group 82, the openings 80 in any one of the opening rows 81 (for example, the opening row 81a) are shifted in the direction BB′ from the openings 80 in the other opening row 81 (for example, the opening row 81b), and are arranged so as to partially overlap the openings 80 in the other opening row 81 (for example, the opening row 81b) when viewed in the direction A. In each opening row 81, the plurality of openings 80 are located at equally-spaced intervals in the direction BB′.

Since the plurality of opening rows 81 are arranged in the direction A to form one opening group 82 as described above, a width of the opening group 82 in the direction BB′ is greater than a width of the recording heads 17a to 17c in the direction BB′. This means that each opening group 82 covers an entire ink discharge area in the direction BB′ of the recording heads 17a to 17c, and the ink discharged from all the ink discharge ports 18 of the recording heads 17a to 17c during flushing passes through any one of the openings 80 in the opening group 82.

In view of the above, the first conveyance belt 8 can be regarded as including the opening groups 82 each including the openings 80 through which the ink discharged from the recording heads 17a to 17c passes during flushing at the plurality of locations at different intervals in the direction A which is the conveyance direction.

### 2-2. Patterns of Opening Groups Used for Flushing

In the present embodiment, the discharge control portion 110a controls the recording heads 17a to 17c to record images on the paper P, while the paper P is conveyed using the first conveyance belt 8, in accordance with the image data transmitted from the outside (for example, the PC). At this time, the recording heads 17a to 17c are made to perform the flushing between the sheets of paper P that are conveyed (flushing between the papers) to reduce or prevent clogging of the ink discharge ports 18.

Here, in the present embodiment, the discharge control portion 110a determines a pattern (combination) of the plurality of opening groups 82 in the direction A used in the flushing in one cycle of the first conveyance belt 8, based on the size of the paper P to be used. The size of the paper P to be used can be recognized by the discharge control portion 110a in accordance with the information stored in the storage 28 (information on the size of the paper P entered by the operation panel 27a) or the image data transmitted with an externally entered printing command. The pattern of the opening groups 82 is literally distinguished from a placement pattern of the paper P, which will be described later.

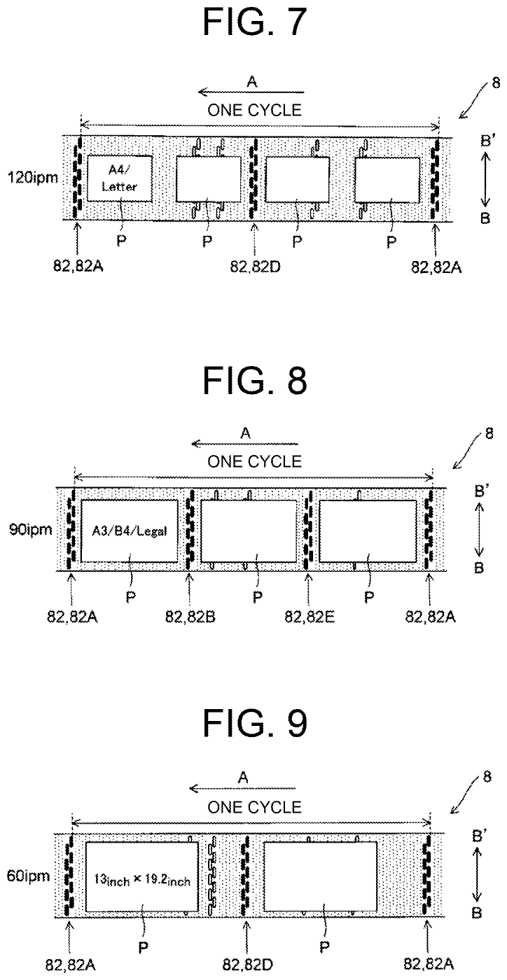

FIGS. 6 to 9 illustrate examples of the pattern of the opening groups 82 for different sized paper P. For example, in the case where the paper P to be used is A4 size (landscape) or letter size (landscape), the discharge control portion 110A selects the pattern of the opening groups 82 illustrated in FIG. 6. In other words, the discharge control portion 110a selects, from the six opening groups 82 illustrated in FIG. 5, the opening groups 82A, 82C, and 82F as the opening groups 82 used for flushing. In the case where the paper P to be used is A4 size (portrait) or letter size (portrait), the discharge control portion 110a selects the opening groups 82A and 82D as the opening groups 82 used for flushing from among the six opening groups 82, as illustrated in FIG. 7. In a case where the paper P to be used is A3 size, B4 size or legal size (all in portrait), the discharge control portion 110a selects the opening groups 82A, 82B, and 82E as the opening groups 82 used for flushing from among the six groups of openings 82, as illustrated in FIG. 8. In the case where the paper P to be used is 13 inches×19.2 inches in size, the discharge control portion 110a selects the opening groups 82A and 82D from among the six opening groups 82 as the opening groups 82 used for flushing, as illustrated in FIG. 9. In each drawing, the openings 80 in the opening groups 82 that belong to the above patterns are illustrated in black for convenience.

The discharge control portion 110a then causes the recording heads 17a to 17c to execute flushing at the timing when the opening groups 82 located according to the determined pattern brought to face the recording heads 17a to 17c by the running of the first conveyance belt 8. Here, the running speed of the first conveyance belt 8 (paper conveyance speed) and the positional relationship of the recording heads 17a to 17c and the opening detection sensor 23 relative to the first conveyance belt 8 are known in advance. Accordingly, when the opening detection sensor 23 detects that the first conveyance belt 8 runs and passes the openings 80 of a predetermined opening group 82, how many seconds after the detection time point the predetermined opening group 82 passes the position facing the recording heads 17a to 17c is known. Therefore, the discharge control portion 110a can cause the recording heads 17a to 17c to execute flushing so that the ink passes through the openings 80 of the opening group 82 located in the pattern determined above by having the recording heads 17a to 17c discharge ink at the discharge timing determined in accordance with the detection result of the openings 80 by the opening detection sensor 23.

### 2-3. Paper Placement Pattern

The paper supply control portion 110b controls the supply of the paper P to the first conveyance belt 8 by the registration roller pair 13 such that the paper P is displaced in the direction A from the opening group 82 located in the pattern determined above. In other words, the paper supply control portion 110b causes the registration roller pair 13 to supply the paper P between the plurality of opening groups 82 lined up in the direction A in the above pattern on the first conveyance belt 8.

For example, when the paper P to be used is A4 size (landscape) or letter size (landscape), the paper supply control portion 110b, the registration roller pair 13 is controlled such that, as illustrated in FIG. 6, two sheets of paper P are placed between the opening groups 82A and 82C on the first conveyance belt 8, two sheets of paper P are placed between the opening groups 82C and 82F, and one sheet of paper P is placed between the opening group 82F and the opening group 82A of the next cycle, thus allowing the paper P to be supplied to the first conveyance belt 8 at predetermined supply timings. At this time, the paper supply control portion 110b controls the registration roller pair 13 to supply the paper P to the first conveyance belt 8 such that the paper P is placed at least a predetermined distance in the direction A (including both upstream and downstream directions) from the opening groups 82A, 82C, and 82F arranged in the above pattern on the first conveyance belt 8. An example of the predetermined distance is set to 10 mm herein.

Here, the paper supply control portion 110b can determine the timing for supplying the paper P by the registration roller pair 13 in accordance with the detection result of the predetermined opening group 82 by the belt sensor 24. For example, when the belt sensor 24 detects that the first conveyance belt 8 runs and pass the reference opening group 82 (for example, the opening group 82A), the paper supply control portion 110b can determine how many seconds after the detection time point the paper P should be supplied to the first conveyance belt 8 by the registration roller pair 13 to place the paper P at respective positions illustrated in FIG. 6. Therefore, the paper supply control portion 110b determines the timing for supplying the paper P in accordance with the detection result of the opening group 82 by the belt sensor 24, and controls the registration roller pair 13 such that the paper P can be supplied at the determined supply timing. In this way, the sheets of paper P can be placed substantially at equally-spaced intervals at respective positions illustrated in FIG. 6 on the first conveyance belt 8. In the example illustrated in FIG. 6, five sheets of paper P can be conveyed in one cycle of the first conveyance belt 8, and 150 images per minute (ipm) can be achieved as the number of printed sheets of paper P (productivity) per minute.

When the paper P to be used is A4 size (portrait) or letter size (portrait), the paper supply control portion 110b controls the registration roller pair 13 to supply the paper P to the first conveyance belt 8 at a predetermined supply timing such that two sheets of paper P are placed between the opening groups 82A and 82D and between the opening group 82D and the opening group 82A of the next cycle on the first conveyance belt 8, as illustrated in FIG. 7. In the example illustrated in FIG. 7, four sheets of paper P can be conveyed in one cycle of the first conveyance belt 8, achieving the productivity of 120 ipm.

When the paper P to be used is A3 size, B4 size or legal size (all in portrait), the paper supply control portion 110b controls the registration roller pair 13 to supply the paper P to the first conveyance belt 8 at a predetermined supply timing such that one sheet of paper P is placed between the opening groups 82A and 82B, one sheet of paper P is placed between the opening groups 82B and 82E, and one sheet of paper P is placed between the opening group 82E and the opening group 82A of the next cycle on the first conveyance belt 8, as illustrated in FIG. 8. In the example illustrated in FIG. 8, three sheets of paper P can be conveyed in one cycle of the first conveyance belt 8, achieving the productivity of 90 ipm.

When the paper P to be used is 13″×19.2″ in size, the paper supply control portion 110b controls the registration roller pair 13 to supply the paper P to the first conveyance belt 8 at a predetermined supply timing such that one sheet of paper P is placed between the opening groups 82A and 82D, and one sheet of paper P is placed between the opening group 82D and the opening group 82A of the next cycle on the first conveyance belt 8, as illustrated in FIG. 9. In the example illustrated in FIG. 9, two sheets of paper P can be conveyed in one cycle of the first conveyance belt 8, achieving the productivity of 60 ipm.

Thus, as illustrated in FIGS. 6 to 9, the pattern of the opening groups 82 used for flushing is determined according to the size of the paper P to be used and, accordingly, the placement pattern of the paper P shifted in the direction A from the opening group 82 is determined. Thus, the placement pattern of the paper P placed on the first conveyance belt 8 can be determined according to the size of the paper P to be used.

Here, the supply speed of the paper P (running speed of the first conveyance belt 8), and the positional relationship between the recording heads 17a to 17c and the paper detection sensor 22 are known in advance. Therefore, when the paper detection sensor 22 detects the passage of the paper P, how many seconds after the detection time point the paper P passes the positions facing the recording heads 17a to 17c is known. Therefore, the discharge control portion 110a causes the ink to be discharged from the recording heads 17a to 17c at the discharge timing determined in accordance with the detection result of the paper P by the paper detection sensor 22, so that the ink discharged from the recording heads 17a to 17c lands on the paper P and the image is recorded on the paper P.

### 3. Flushing Timing Adjustment

In normal printing, as described in (2-3) above, the discharge control portion 110a causes the ink to be discharged from the recording heads 17a to 17c at the first discharge timing determined in accordance with the detection time point when the paper P is detected by the paper detection sensor 22. Here, it is assumed that the first discharge timing is set, for example, at the time when time T1 (unit: second) has elapsed after the detection time point of the paper P by the paper detection sensor 22. When executing flushing, as described in (2-2) above, the discharge control portion 110a causes the ink to be discharged from the recording heads 17a to 17c at the second discharge timing determined in accordance with the detection time point of the openings 80 by the opening detection sensor 23. Here, it is assumed that the second discharge timing is set, for example, at the time when time T2 (unit: second) has elapsed after the detection time point of the paper P by the opening detection sensor 23. Since the paper detection sensor 22 is located upstream of the opening detection sensor 23 with respect to the recording heads 17a to 17c (recording portion 9), T1>T2 is satisfied.

The second discharge timing mentioned above varies for each device (printer 100), depending on the detection tolerance and the installation tolerance of the opening detection sensor 23. To facilitate handling of such variations in the second discharge timing from device to device, the second discharge timing is adjusted by means described later for each device in the present embodiment. Before describing the adjustment of the second discharge timing or the flushing timing, the opening detection sensor 23 described above used to adjust the flushing timing is described in details.

### 3-1. Details of Opening Detection Sensor

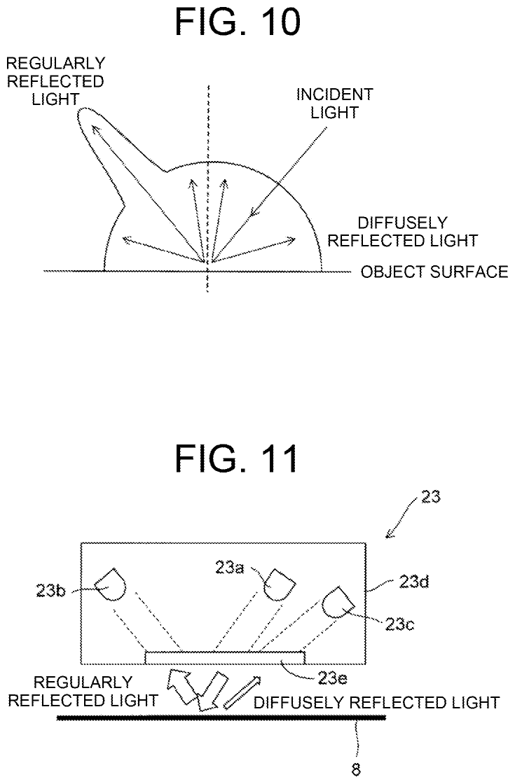

In the present embodiment, an optical analog sensor (optical sensor) that detects both regularly reflected light and diffusely reflected light is used as the opening detection sensor 23. Such an optical sensor is also called an image density sensor (ID sensor). FIG. 10 schematically illustrates a light amount distribution of reflected light (regularly and diffusely reflected lights) when an object is irradiated with light. As illustrated in the drawing, when an object is irradiated with light, the light is reflected on the surface of the object. At this time, the distribution of the amount of light of the reflected light (ratio of the light amount of the regularly reflected light to the diffusely reflected light) is determined by the characteristics of the object (for example, refractive index) when the light incident angle is constant. The ID sensor uses such a change in the distribution of the light amount of the reflected light according to the characteristics of the object and is usually used as sensors to detect the state of the detected object (for example, image density).

FIG. 11 is a cross-sectional view schematically illustrating the structure of the opening detection sensor 23. The opening detection sensor 23 includes a light source 23a which is, for example, made up of an LED, a first light receiving portion 23b that detects the regularly reflected light, a second light receiving portion 23c that detects the diffusely reflected light, and a housing 23d. The first and second light receiving portions 23b and 23c include, for example, photodiodes. The light emitted from the light source 23a is transmitted through the lens 23e provided on the housing 23d and irradiates the first conveyance belt 8. Of the light reflected from the first conveyance belt 8, the regularly reflected light passes through the lens 23e again and is received by the first light receiving portion 23b. Thus, the first light receiving portion 23b outputs a signal corresponding to the intensity of the regularly reflected light. Of the light reflected by the first conveyance belt 8, the diffusely reflected light that passes through the lens 23e again and is received by the second light receiving portion 23c. Therefore, the second light receiving portion 23c outputs a signal corresponding to the intensity of the diffusely reflected light.

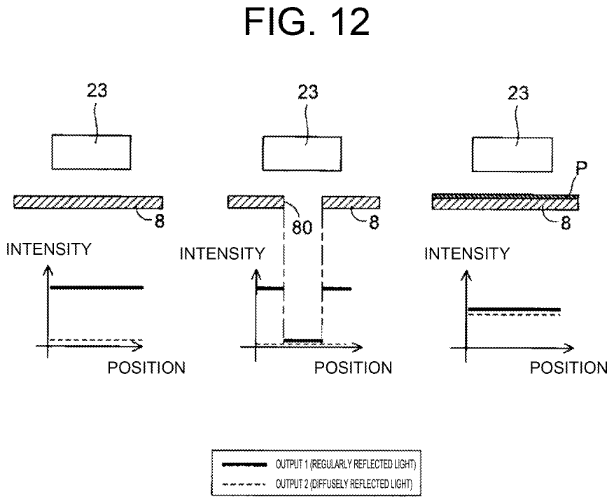

FIG. 12 schematically illustrates variations in the signals output from the opening detection sensor 23. In FIG. 12, the signal output from the first light receiving portion 23b is referred to as “output 1”, and the signal output from the second light receiving portion 23c is referred to as “output 2.”

As illustrated on the left-hand side of FIG. 12, in a case where the object is the first conveyance belt 8, the level (intensity) of the output 1 is relatively high and the level of the output 2 is relatively low. As illustrated in the center of FIG. 12, when the light enters the opening 80 of the first conveyance belt 8, the light passes through the opening 80, so that the levels of both output 1 and output 2 are low.

On the other hand, as illustrated on the right-hand side of FIG. 12, when the light is incident on the paper P on the first conveyance belt 8, the level of the output 1 is lower and the level of the output 2 is higher, because the degree of diffusion of the incident light increases compared to the case where light is incident directly on the first conveyance belt 8. The levels of the output 1 and the output 2 should change depending on the type of the paper P to be used (glossiness, whiteness, or the like) and the sensitivity of the light receiving portions.

Thus, by using the ID sensor that detects the reflected light and the diffusely reflection light as the opening detection sensor 23, the controller 110 (for example, the discharge control portion 110a) can determine, in accordance with the output signal from the opening detection sensor 23, whether the object passing through the position facing the opening detection sensor 23 is (i) the first conveyance belt 8, (ii) the opening 80 of the first conveyance belt 8, or (iii) the paper P on the first conveyance belt 8. The output signal gain may be adjusted according to the sensitivity of the first and second light receiving portions 23b and 23 of the opening detection sensor 23, so that the controller 110 can clearly distinguish the above three states.

### 3-2. Flushing Timing Adjustment Method

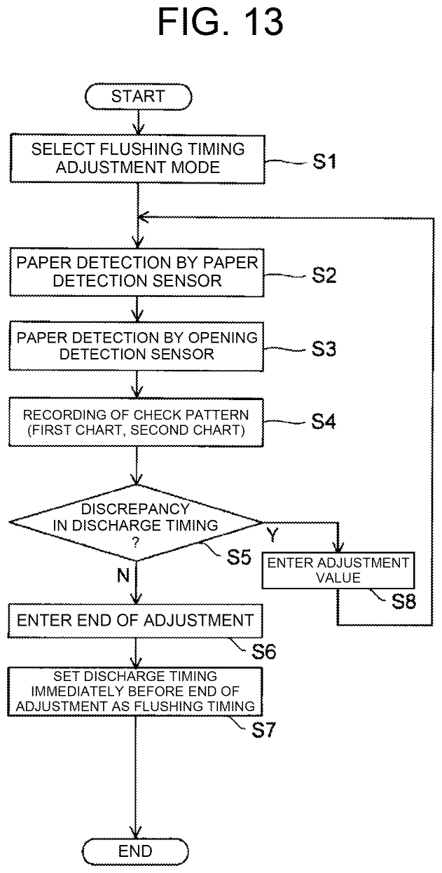

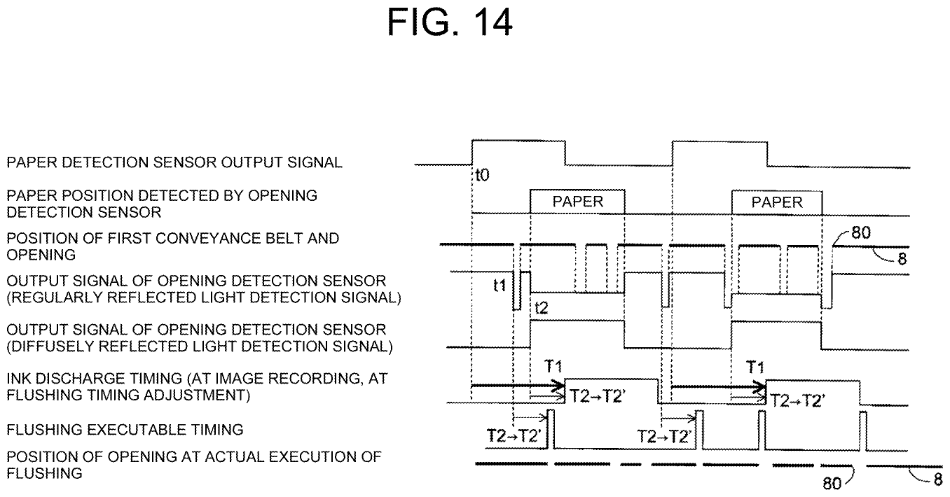

Next, a flushing timing adjustment method using the opening detection sensor 23 described above is described. FIG. 13 is a flowchart illustrating the flow of the operation of the flushing timing adjustment method according to the present embodiment. FIG. 14 is a timing chart illustrating the output signal of the paper detection sensor 22, the output signal of the opening detection sensor 23 (regularly reflected light detection signal, diffusely reflected light detection signal), an ink discharge timing (during image recording, during flushing), and a flushing executable timing, when the paper P is supplied on the first conveyance belt 8 having the openings 80. The paper P is adsorbed and conveyed on the first conveyance belt 8, so that the conveyance speed of the first conveyance belt 8 is the same as the conveyance speed of the paper P.

First, for example, in the factory settings of the device (printer 100), an operator involved in manufacturing the device operates the operation panel 27 to select a flushing timing adjustment mode (S1). This selection of the mode allows the opening detection sensor 23, which normally detects the openings 80 moved by the running of the first conveyance belt 8, to be used as a sensor to detect the paper P, and allows the ink to be discharged from the recording heads 17a to 17c in accordance with the detection of the paper P by the opening detection sensor 23.

Next, when the paper detection sensor 22 detects the paper P fed to the first conveyance belt 8 by the registration roller pair 13 (S2), and the opening detection sensor detects the paper P conveyed by the first conveyance belt 8 (S3), the discharge control portion 110a controls the discharge of the ink by the recording heads 17a to 17c to record a check pattern (first chart, second chart) on the paper P (S4).

Specifically, in S4, the discharge control portion 110a causes the recording heads 17a to 17c to discharge inks from predetermined nozzles (ink discharge ports 18) at a plurality of predetermined discharge timings set in advance using the detection time point t0 of paper P as a reference time point by the paper detection sensor 22 to record a first chart C1 on the paper P. The discharge control portion 110a also causes the recording heads 17a to 17c to discharge ink from other nozzles at the plurality of discharge timings set in advance using the detection time point t2 of the paper P by the opening detection sensor 23 as the reference time point, thus recording the second chart C2 on the paper P alongside the first chart C1.

FIG. 15 schematically illustrates an example of a first chart C1 and a second chart C2. The first chart C1 includes a first reference line Cr1 and a plurality of first auxiliary lines Cs1. The first reference line Cr1 is a line formed by the ink discharged at a reference discharge timing (for example, after time T1 has elapsed from the detection time point t0 of the paper P by the paper detection sensor 22) from predetermined nozzles of the recording heads 17a to 17c in accordance with the detection of the paper P by the paper detection sensor 22. The first auxiliary lines Cs1 are lines formed by the ink discharged at a plurality of timings before and after the reference discharge timing from the predetermined nozzles. The plurality of the first auxiliary lines Cs1 are arranged with the first reference line Cr1 on the paper P in the conveyance direction of the paper P. The first reference line Cr1 and the plurality of first auxiliary lines Cs1 are formed on the paper Pin the longitudinal direction of the recording heads 17a to 17c, that is, in parallel with the width direction (belt width direction) of the paper P.

In the drawing, “A to I, 0 to 9” are signs given for convenience corresponding to each position of the first reference line Cr1 and the plurality of first auxiliary lines Cs1. Of these signs, the sign “0” corresponds to the position of the first reference line Cr1, and the signs “A-I, 1 to 9” correspond to the positions of the first auxiliary line Cs1. In particular, the signs “1 to 9” are given to the first auxiliary lines Cs1 located on the upstream side of the first reference line Cr1 in this order upstream from the first reference line Cr1. The signs “A to I” are given to the first auxiliary lines Cs1 located on the downstream side of the first reference line Cr1 in this order downstream from the first reference line Cr1.

It is assumed that the interval between the discharges of ink to form the first reference line Cr1 and the plurality of the first auxiliary lines Cs1 is, for example, 50 μsec. Therefore, using the discharge timing of the first reference line Cr1 as a reference timing, the ink discharge timing for forming each line of the first chart C1 is, for example, T1−50 (μsec), T1−50×2 (ρsec), T1−50×3 (μsec), . . . , upstream from the first reference line Cr1, and, for example, T1+50 (μsec), T1+50×2 (μsec), T1+50×3 (μsec), . . . , downstream from the first reference line Cr1.

On the other hand, the second chart C2 includes a second reference line Cr2 and a plurality of second auxiliary lines Cs2. The second reference line Cr2 is a line formed by the ink discharged at a reference discharge timing (for example, after time T2 has elapsed from the detection point t2 of the paper P by the opening detection sensor 23) from other nozzles of the recording heads 17a to 17c in accordance with the detection of the paper P by the opening detection sensor 23. The second auxiliary lines Cs2 are lines formed by the ink discharged at a plurality of timings before and after the reference discharge timing from the other nozzles. The plurality of the second auxiliary lines Cs2 are lined up with the second reference line Cr2 on the paper P in the conveyance direction of the paper P. The second reference line Cr2 and the plurality of second auxiliary lines Cs2 are formed on the paper P in the longitudinal direction of the recording heads 17a to 17c, that is, in parallel with the width direction (belt width direction) of the paper P.

It is assumed that the ink discharge interval to form the second reference line Cr2 and the plurality of the second auxiliary lines Cs2 is, for example, 60 μsec. Therefore, using the discharge timing of the second reference line Cr2 as a reference discharge timing, the ink discharge timing to form the lines of the second chart C2 is, for example, T1−60 (μsec), T1−60×2 (μsec), T1−60×3 (μsec), . . . , upstream from the second reference line Cr2, and, for example, T1+60 (μsec), T1+60×2 (μsec), T1+60×3 (μsec), . . . , downstream from the second reference line Cr2.

Thus, the ink discharge interval to form the lines is different between the first chart C1 and the second chart C2. Therefore, an interval D1 between all lines included in the first chart C1 in the conveyance direction of the paper P (first reference line Cr1, first auxiliary lines Cs1) is different from a distance D2 between all lines included in the second chart C2 (second reference line Cr2, second auxiliary lines Cs2) in the conveyance direction of the paper P. For example, D1<D2 is satisfied in the present embodiment.

Once the check pattern illustrated in FIG. 15 is recorded on the paper P, the operator can see the first chart on the paper P, C1 and the second chart C2, and then determine whether and to what extent there is a discrepancy between the ink discharge timing based on the paper detection by the paper detection sensor 22 and the ink discharge timing based on the paper detection by the opening detection sensor 23. For example, in the example of FIG. 15, the first reference line Cr1 of the first chart C1 is aligned with the second reference line Cr2 of the second chart C2, meaning that the timings match up, so that the operator can determine that the ink discharge timings of the two charts match up (no discrepancy in discharge timing).

Thus, when the operator sees the paper P on which the check pattern is recorded in S4 and determines that both ink discharge timings match up (No in S5), there is no need to change the flushing timing, and the operator operates the operation panel 27 to enter the end of the flushing timing adjustment (S6). In this case, the discharge control portion 110a sets (maintains), as the flushing timing, the reference discharge timing immediately before the end of the flushing timing adjustment, that is, the ink discharge timing to form the second reference line Cr2 (after time T2 from the detection time point), in accordance with the detection time point t1 of the openings 80 by the opening detection sensor 23, and stores the flushing timing in the storage 28.

When the flushing is executed in the installation environment on the user side after shipment of the device, the discharge control portion 110a causes the nozzles of the recording heads 17a to 17c to discharge ink after time T2 has elapsed from the detection time point t1 of the opening 80 by the opening detection sensor 23. With the flushing timing set as described above, the ink discharged from the recording heads 17a to 17c can pass through the openings 80.

When the normal printing is performed in the installation environment on the user side, the discharge control portion 110a can allow the image to be recorded on the paper P by discharging the ink from the recording heads 17a to 17c after time T1 has elapsed from the detection time point t0, using the detection time point t0 when the paper P is detected by the paper detection sensor 22 as the reference time point.

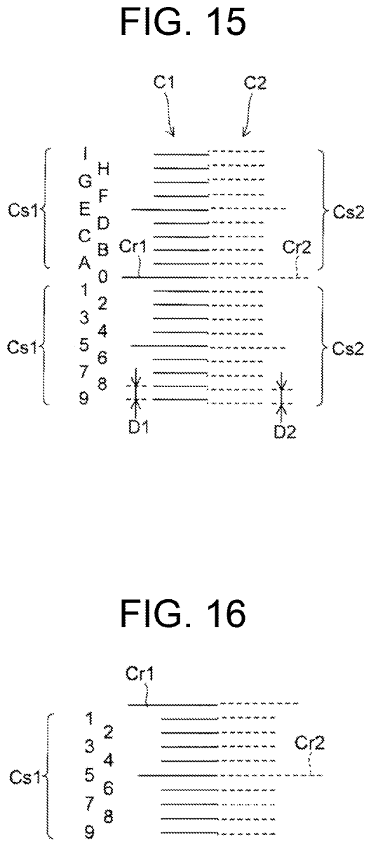

On the other hand, FIG. 16 schematically illustrates a state in which a positional discrepancy has occurred between the first chart C1 and the second chart C2. As illustrated in the drawing, when the first reference line Cr1 and the second reference line Cr2 are misaligned in the paper conveyance direction, the operator can determine that there is a discrepancy between the ink discharge timing based on paper detection by the paper detection sensor 22 and the ink discharge timing based on paper detection by the opening detection sensor 23. In the example of FIG. 16, the second reference line Cr2 of the second chart C2 is shifted in the direction of earlier discharge timing by five tick marks of the first auxiliary lines Cs1 of the first chart C1, meaning that the amount of the temporal discrepancy of the ink discharge timing is expressed by one tick mark of the ink discharge interval (50 μsec)×number of tick marks (−5)=−250 μsec (negative signs indicate that the discharge timing is earlier than the reference timing).

Thus, when the operator sees the paper P on which the check pattern is recorded in S4 and determines that there is a discrepancy between the ink discharge timing based on the paper detection by the paper detection sensor 22 and the ink discharge timing based on the paper detection by the opening detection sensor 23 (Yes at S5), the flushing timing needs to be changed, and the operator operates the operation panel 27 to enter the flushing timing adjustment value (S8). For example, in the example of FIG. 16, the operator enters a value corresponding to the amount of temporal discrepancy of the ink discharge timing as the adjustment value. As the adjustment value, for example, the number of tick marks on the scale indicating the amount of discrepancy (for example, “−5”) or a value of the discrepancy amount itself (for example, “−250”) can be used.

Thus, the discharge control portion 110a changes the ink discharge timing to form the lines of the second chart C2 according to the discrepancy amount. For example, the discharge control portion 110a changes the ink discharge timing to form the second reference line Cr2 from “after time T2 from the detection time point of the openings 80 by the opening detection sensor 23” to “after time T2′ from the detection time point of the openings 80 by the opening detection sensor 23”. In the above example, T2′ (sec)=T2 (sec)+250 (μsec)=T2+0.25 (sec). In addition, the discharge control portion 110a changes the ink discharge timing to form the plurality of second auxiliary lines Cs2 by back calculation in accordance with the ink discharge timing (after the change) to form the second reference line Cr2. The process then returns to S2 and repeats the process from S2 onward.

Subsequently, if the operator sees the paper P with the check pattern recorded in S4 and there is a discrepancy between the ink discharge timing based on the paper detection by the paper detection sensor 22 and the ink discharge timing based on the paper detection by the opening detection sensor 23, the operator enters the adjustment value again in S8 and repeats the above process.

On the other hand, if the operator determines in S4 that there is no discrepancy, the operator proceeds to S6 and operates the operation panel 27 to enter the end of flushing timing adjustment. In this case, the discharge control portion 110a sets, as the flushing timing, the reference discharge timing immediately before the end of the flushing timing adjustment, that is, the ink discharge timing to form the second reference line Cr2 (after time T2′ from the detection time point of the openings 80 by the opening detection sensor 23), in accordance with the detection time point of the openings 80 by the opening detection sensor 23), and stores the flushing timing in the storage (S7).

When executing the flushing in the installation environment on the user side after the device is shipped, the discharge control portion 110a causes the ink to be discharged from the nozzles of the recording heads 17a to 17c after time T2′ has elapsed from the detection time point t1 of the openings 80 by the opening detection sensor 23. As a result, the ink discharged from the recording heads 17a to 17c at the adjusted flushing timing passes through the openings 80 in the first conveyance belt 8.

The example of adjusting the flushing timing for any one of the openings 80 in each of the opening groups 82 has been described above, but as in the present embodiment, in the structure in which the openings 80 of each opening group 82 are arranged in the staggered manner, a time difference in flushing timing needs to be provided between the first row (for example, the opening row 81a) and the second row (for example, the opening row 81b) of each opening group 82. The positional information of the openings 80 of one opening group 82 (positional information of the openings 80 of the opening row 81a and openings 80 of the opening row 81b) is stored in the storage 28 in advance, and the running speed of the first conveyance belt 8 is constant, so that the above time difference can be obtained by calculation.

For example, when the flushing timing for the openings 80 of the opening row 81a is set (maintained or changed) in the above manner, the flushing timing for the openings 80 of the next opening row 81b can be set (maintained or changed) by adding the above time difference to the flushing timing for the openings 80 of the opening row 81a. By causing the ink to be discharged from the corresponding nozzles of the recording heads 17a to 17c at the flushing timing set above, it is possible to execute flushing to allow the ink to pass through the openings 80 of opening row 81b.

### 4. Effect

As described above, the present embodiment uses the opening detection sensor 23, which originally detects the openings 80, as a sensor to detect the paper P, thus discharging the ink at the timing in accordance with the detection of the paper P by the paper detection sensor 22 to record the first chart C1 on the paper P, while recording the second chart C2 on the paper P by discharging the ink at the discharge timing in accordance with the detection of the paper P by the opening detection sensor 23 (S2 to S4). After the first chart C1 and the second chart C2 are recorded on the paper P, the flushing timing, which is set using the detection time point of the openings 80 by the opening detection sensor 23, is adjusted in accordance with the input of instruction from the operation panel 27 (S6 to S8). The flushing timing adjustment may include changing the flushing timing in accordance with the input of the adjustment value in S8, and also include maintaining the initial setting of the flushing timing without change in accordance with the input of the end of adjustment in S6.

By recording the first chart C1 and the second chart C2 on the paper P as described above, the operator who is involved in the manufacturing of the device can see the first chart C1 and the second chart C2 to easily determine whether the ink discharge timing based on the detection by the opening detection sensor 23 matches the normal timing. In other words, the operator can easily determine whether the ink discharge timing during flushing in accordance with the detection of opening 80 by the opening detection sensor 23 is correct (whether the discharged ink can pass through the openings 80) by comparing the image (second chart C2) obtained by actually discharging ink onto the paper P at the timing based on the detection of paper P by the opening detection sensor 23 (second chart C2) and another image (first chart C1) obtained by discharging ink at the timing based on the detection of the paper P by another sensor (paper detection sensor 22). The operator can then enter the instruction to adjust (change or maintain) the flushing timing in accordance with the determination result.

In addition, the user of the manufactured printer 100 can also recognize the state of the printer 100 by letting the printer 100 to record the check pattern (first chart C1 and second chart C2).

When the user feels that the printer 100 may be malfunctioning, the user can operate the operation panel 27 to have the check pattern recorded. The user can find information about recording such check patterns from the help screen stored in the storage 28 and displayed on the operation panel 27 or in the manuals that come with the printer 100. By viewing the check pattern according to the help screen or the manuals, the user can determine the state of the printer 100 with respect to the ink discharge timing during flushing. Alternatively, the user can send the check pattern to the manufacturer, the distributor, or the like of the printer 100 to check the state of the printer 100.

When the check pattern indicates that the printer 100 should be adjusted, the user may adjust the flushing timing in the same way as the operator described above, or may ask someone who manufactured or sold the printer 100 to make the adjustment.

The main control portion 110c may record the check pattern at predetermined intervals to allow the user to check the state of the printer 100. The interval between recordings may be by the number of sheets printed or by time, such as the elapsed time or the operating time of the printer 100. Instead of recording the check pattern, the main control portion 110c may cause the operation panel 27 to display to urge recording of the check pattern at predetermined intervals.

On the device side, the flushing timing is adjusted for each device in accordance with the input of the instruction. Even when the opening detection sensor 23 has the tolerance (detection tolerance, installation position tolerance), the ink can be discharged from the recording heads 17a to 17c at an appropriate flushing timing for each device and made to accurately pass through the openings 80 to execute the flushing in the installation environment on the user side after the device is shipped. This eliminates the need to form larger openings 80 in the first conveyance belt 8 to reduce the effect of the tolerance of the opening detection sensor 23. As a result, the following effects can further be obtained.

Specifically, the size of the openings 80 can be kept to the minimum necessary, thus suppressing the decrease of the strength of the first conveyance belt 8. Even when the paper P is placed to overlap the openings 80 that are not used for flushing on the first conveyance belt 8 during the normal image formation, the deflection of the paper P toward the inside of the openings 80 can be suppressed due to the small size of the openings 80. Thus, the degradation in quality of the recorded image caused by the deflection of the paper P can be suppressed.

Since the effect of the tolerance of the opening detection sensor 23 is reduced, it is possible to expand the design margin of the device regarding the installation and assembly of the components including the opening detection sensor 23.

According to the flushing timing adjustment method of the present embodiment, the flushing timing can be easily adjusted in accordance with the input of instruction by the operator, thus simplifying the work required for the adjustment.

In particular, in S6, the flushing timing is adjusted in accordance with the adjustment value entered after the first chart C1 and the second chart C2 are recorded on the paper P. This makes it possible to change the flushing timing appropriately in accordance with the adjustment value.

The first chart S1 includes the first reference line Cr1 and the second chart S2 includes the second reference line Cr2. By recording the first chart C1 and the second chart C2 on the paper P, the operator can easily recognize whether there is a discrepancy between the ink discharge timing based on the detection of the paper P by the paper detection sensor 22 and the ink discharge timing based on the detection of the paper P by the opening detection sensor 23 in accordance with the positional discrepancy between the first reference line Cr1 of the first chart C1 and the second reference line Cr2 of the second chart C2 in the conveyance direction of the paper P. Therefore, the operator can easily determine whether it is necessary to adjust the flushing timing (ink discharge timing based on the detection of the openings 80 by the opening detection sensor 23).

The first chart C1 further includes the plurality of the first auxiliary lines Cs1, and the second chart C2 further includes the plurality of the second auxiliary lines Cs2. In this case, the operator can recognize and recognize easily the amount of discrepancy between the first reference line Cr1 of the first chart C1 and the second reference line Cr2 of the second chart C2 in the paper P conveyance direction by corresponding it to the time interval between the first reference line Cr1 and the first auxiliary line Cs1 formed by matching the discharge timing with the second reference line Cr2. Specifically, in the example of FIG. 15, the operator can easily recognize the amount of discrepancy of the discharge timing between the first reference line Cr1 and the second reference line Cr2 by corresponding it to the time interval (for example, 50 μsec×5 (absolute value)) between the first reference line Cr1 and the first auxiliary line Cs1 marked with the number “5” formed by matching the discharge timing with the second reference line Cr2.

The interval D1 between all lines of the first chart C1 in the conveyance direction of the paper P is different from the interval D2 between all lines of the second chart C2 in the conveyance direction of the paper P (see FIG. 14). In this case, the operator can easily find the lines formed at the matched discharge timing in the first chart C1 and the second chart C2. This further allows the operator to easily recognize the discrepancy amount between the first reference line Cr1 and the second reference line Cr2.

The opening detection sensor 23 is the optical sensor that detects both the regularly reflected light and the diffusely reflected light. By using such an opening detection sensor 23, the discharge control portion 110a can reliably distinguish and recognize whether the detection target is the first conveyance belt 8 (area on which the paper P is not placed), the openings 80 of the first conveyance belt 8, or the paper P on the first conveyance belt 8, in accordance with the output signals from the opening detection sensor 23, that is, the detection signal of the regularly reflected light and the detection signal of the diffusely reflected light. This ensures the implementation of the flushing timing adjustment method described above using the opening detection sensor 23. The ID sensor that detects both the regularly reflected light and the diffusely reflected light can be used as the opening detection sensor 23, thus effectively utilizing the ID sensor.

The opening detection sensor 23 may be a reflective optical sensor that detects the regularly reflected light. The reflective optical sensor outputs the detection signal such as the output 1 illustrated in FIG. 12, so that the discharge control portion 110a can distinguish and recognize, in accordance with the detection signal of the regularly reflected light, whether the detection target is the first conveyance belt 8, the openings 80 of the first conveyance belt 8, or the paper P on the first conveyance belt 8, thus implementing the flushing timing adjustment method of the present embodiment. The flushing timing adjustment method of the present embodiment is applicable to the case where the conveyance of paper is controlled to be completely separated from the openings of the conveyance belt, as in Patent Literature 3, for example. In this case, the reflective optical sensor can be used as the opening detection sensor 23.

In the example described above, the operator directly operates the operation panel 27 to enter the instruction on the flushing timing (enter the instruction to end the adjustment or enter the adjustment value). Alternatively, the operator may enter the instructions on the PC. In this case, the device (printer 100) receives the input of the instruction via the communication portion 29, and the flushing timing is adjusted on the device side in accordance with the input of the instruction.

According to the above description, the inkjet recording device (printer 100) that is directly used to implement the flushing timing adjustment method described above can be expressed as below. Specifically, the inkjet recording device includes the recording heads 17a to 17c each having the plurality of nozzles, the endless first conveyance belt 8 that conveys the paper P and includes the openings 80 at the plurality of locations in the conveyance direction of the paper P, the ink passing through the openings 80 during the execution of the flushing to discharge the ink at the timing different from the timing at which the recording heads 17a to 17c contribute to the image formation, the registration roller pair 13 that supplies the paper P to the first conveyance belt 8, the paper detection sensor 22 that detects the paper P to be supplied to the first conveyance belt 8 through the registration roller pair 13, the opening detection sensor 23 that detects the openings 80 that move by the running of the first conveyance belt 8 and detects the paper P on the first conveyance belt, and the discharge control portion 110a that controls the ink discharge by the recording heads 17a to 17c. The discharge control portion 110a causes the ink to be discharged from the predetermined nozzles of the recording heads 17a to 17c at the plurality of discharge timings set in advance using the detection time point of the paper P by the paper detection sensor 22 as the reference time point to record the first chart C1 on the paper P, while causing the ink to be discharged from other nozzles of the recording heads 17a to 17c at the plurality of discharge timings set in advance using the detection time point of the paper P by the opening detection sensor 23 as the reference time point to record the second chart C2 alongside the first chart C1 on the paper P. The printer 100 further includes the input accepting portion 30 (operation panel 27, communication portion 29) that accepts the input of the instruction for the flushing timing adjustment which indicates the timing for discharging the ink when the recording heads 17a to 17c execute the flushing. The discharge control portion 110a adjusts the flushing timing set by using the detection time point of the openings 80 by the opening detection sensor 23 as the reference time point, in accordance with the input of instruction accepted by the input accepting portion 30.

### 5. Another Example of Check Pattern

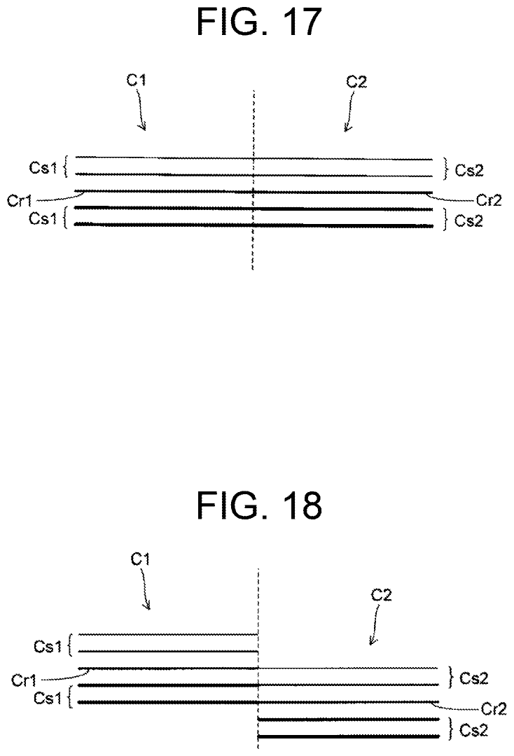

FIG. 17 schematically illustrates another example of the first chart C1 and the second chart C2 which are recorded on the paper P during the flushing timing adjustment. As illustrated in the drawing, the interval of all lines included in the first chart C1 (first reference line Cr1, first auxiliary lines Cs1) in the paper conveyance direction may be identical to the interval of all lines included in the second chart C2 (second reference line Cr2, second auxiliary lines Cs2) in the paper conveyance direction. The line widths of all lines in the first chart C1 are different from each other, and the line widths of all lines in the second chart C2 are different from each other. The first chart C1 may include lines having the line widths identical to the line widths of the lines in the second chart C2.

FIG. 18 schematically illustrates the state in which the positional discrepancy has occurred between the first chart C1 and the second chart C2 formed as illustrated in FIG. 17. When such first and second charts C1 and C2 are recorded on the paper P, the operator can also recognize the positional discrepancy between the first chart C1 and the second chart C2 in the flushing timing adjustment mode. In other words, in accordance with such first and second charts C1 and C2, the operator can recognize the discrepancy between the ink discharge timing based on the detection of the paper P by the paper detection sensor 22 and the ink discharge timing based on the detection of the paper P by the opening detection sensor 23. Therefore, even when these first and second charts C1 and C2 are recorded on the paper P, the operator can easily determine whether the flushing timing adjustment is necessary according to the first and second charts C1 and C2.

### 6. Identifying Flushing Executable Timing (Part 1)

In the printer 100 according to the present embodiment, as illustrated in FIGS. 6 to 9, in which the flushing is performed in a manner that the ink passes through the openings 80 of the opening groups 82 (portions painted in black) provided in the pattern corresponding to the size of the paper P, the sheets of paper P are supplied to the first conveyance belt 8 such that each paper P is displaced from the openings 80 in the paper conveyance direction. To control such paper conveyance, the discharge control portion 110a may identify the flushing executable timing in accordance with the detection result of the openings 80 by the opening detection sensor 23 and the detection result of the paper P by the opening detection sensor 23. The flushing executable timing is the ink discharge timing at which the ink discharged from the recording heads 17a to 17c in the execution of flushing passes through at least part of any one of the openings 80 among the openings 80 of the opening groups 82 located at the plurality of positions in the paper conveyance direction.

For example, as illustrated in FIG. 6, when the sheets of A4 size (landscape) paper P are supplied to the first conveyance belt 8 at equally-spaced intervals, the opening detection sensor 23 detects the openings 80 of the opening groups 82A, 82C, and 82F. The paper P is placed overlapping the openings 80 of opening groups 82B, 82D, and 82E, so that the opening detection sensor 23 cannot detect these openings 80 (the opening detection sensor 23 detects the paper P). Therefore, the discharge control portion 110a can identify the timing at which the openings 80 of the opening groups 82A, 82C, and 82F detected by the opening detection sensor 23 by the running of the first conveyance belt 8 are brought to face the recording heads 17a to 17c as the flushing executable timing as described above.

By identifying the flushing executable timing by the discharge control portion 110a, the ink can be discharged, in the actual execution of the flushing, from the recording heads 17a to 17c at least at one identified flushing executable timing to pass through the openings 80 that do not overlap the paper P. Thus, the flushing can be performed with accuracy.

Even when the supply of the paper P to the first conveyance belt 8 is controlled such that the paper P is shifted from the opening groups 82A, 82C, and 82F on the first conveyance belt 8, it may be possible that the conveyance of the paper P is delayed for some reason (for example, slippage on the surface of the rollers on the way to the first conveyance belt 8) and the paper P is placed on top of the openings 80 of opening groups 82A, 82C, and 82F. In this case, the flushing executable timing is identified in the upstream vicinity of the recording heads 17a to 17c in accordance with the detection of the actual openings 80 and the paper P by the opening detection sensor 23. Therefore, the opening detection sensor 23 does not detect the openings 80 where the paper P overlaps the openings 80, and the timing when the recording heads 17a to 17c face such openings 80 is not identified as the flushing executable timing. This avoids the execution of flushing at the timing when such openings 80 face the recording heads 17a to 17c, and prevents soiling of the paper P overlapping the openings 80 with ink during flushing.

In a case where the paper P is placed overlapping the openings 80 to be flushed for some reason as described above, the discharge control portion 110a may avoid the flushing for such openings 80, or may also control to perform the following alternative measures (1) to (3).

(1) When the opening detection sensor 23 detects, subsequent to the paper P placed on top of the openings 80, openings 80 (openings 80 other than the openings 80 located in the pattern corresponding to the size of the paper P) that are not scheduled to perform the flushing, the discharge control portion 110a may cause the recording heads 17a to 17c to execute the flushing for such openings 80 (at the timing when such openings 80 are brought to face the recording heads 17a to 17c).

(2) The discharge control portion 110a may cause the recording heads 17a to 17c to execute the flushing (stir flushing) for the paper P that overlaps the openings 80 (at the timing when the paper P faces the recording heads 17a to 17c). In this case, it is desirable to discharge the ink in a dispersed manner to the paper P so as not to affect the quality of the recorded image on the paper P.

(3) The paper supply control portion 110b may control the registration roller pair 13 to delay the conveyance of the next paper P to be supplied, so that the openings 80 appear between the paper P that is placed on top of the openings 80 and the next paper P to be supplied. Then, the discharge control portion 110a may cause the recording heads 17a to 17c to execute the flushing for such openings 80 located between the two sheets of paper P (at the timing when the openings 80 face the recording heads 17a to 17c).

When the flushing is performed for the paper P, the main control portion 110c, for example, displays an error on the operation panel 27 to notify to the outside that such flushing has been performed. It may also be possible that, depending on the frequency that the paper P overlaps the openings 80 to be flushed, the paper supply control portion 110b may control the registration roller pair 13 to control the supply timing of the paper P and correct the placement position of the paper P on the first conveyance belt 8. In addition, the main control portion 110c may cause the operation panel 27 to display to urge cleaning of the first conveyance belt 8 according to the frequency, so as to reduce the possibility that the back side of the paper P (side that is in contact with the first conveyance belt 8) that overlaps the openings 80 is soiled with ink that is adhered around the openings 80.

In the above, the first conveyance belt 8 may be provided using the belt having the plurality of opening groups 82 which are irregularly positioned in the paper conveyance direction (the interval between the opening group 82 in the paper conveyance direction changes). Alternatively, a belt having the opening groups 82 or the openings 80 located at equally-spaced intervals in the paper conveyance direction and at intervals equal to or smaller than the length of the smallest size paper P in the paper conveyance direction. When using such a first conveyance belt 8, for example, the paper supply control portion 110b can control the registration roller pair 13 such that the plurality of sheets of paper P are placed on the first conveyance belt 8 at constant intervals and supply the sheets of paper P sequentially to the first conveyance belt 8 regardless of the positions of the openings 80 of the first conveyance belt 8. In this case, the discharge control portion 110a can also use the same method as above, that is, in accordance with the detection results of the openings 80 and the paper P by the opening detection sensor 23, identifying the flushing executable timing and causing the recording heads 17a to 17c to execute the flushing, thus obtaining the same effect as above.

If the plurality of flushing executable timings are identified, the discharge control portion 110a may cause the recording heads 17a to 17c to execute flushing at all of the identified flushing executable timings, or may cause the recording heads 17a to 17c to execute the flushing at some of the identified flushing executable timings. For example, the discharge control portion 110a may select the timing to actually discharge ink from the recording heads 17a to 17c from the plurality of flushing executable timings depending on the usage state of each nozzle of the recording heads 17a to 17c, and cause the recording heads 17a to 17c to execute flushing at the selected timing. In this case, the flushing can be executed by the recording heads 17a to 17c at the minimum necessary timings to obtain the effect of preventing nozzle clogging by flushing. The usage state of each nozzle may be determined by the discharge control portion 110a in accordance with, for example, the image data used for printing (image data of the image recorded on the paper P). Therefore, by executing flushing according to the usage state of each nozzle, unnecessary flushing can be avoided and the increase in ink consumption due to unnecessary flushing can be avoided.

### 7. Identifying Flushing Executable Timing (Part 2)

As illustrated in FIG. 5, the first conveyance belt 8 of the present embodiment has the plurality of openings 80 arranged in the staggered manner in one opening group 82. More specifically, the first conveyance belt 8 has the opening groups 82 at the plurality of locations in the paper conveyance direction. Each opening group 82 includes the plurality of opening rows 81 each including the openings 80 arranged in the belt width direction perpendicular to the paper conveyance direction. The openings 80 in each opening row 81 of each opening group 82 are shifted from the openings 80 of the adjacent opening row 81 in the belt width direction in a manner that the openings of the opening row partially overlap the openings of the adjacent opening row when viewed in the conveyance direction.

The opening detection sensor 23 used in the present embodiment is sized to detect one opening 80 (see FIG. 5). In this case, the opening detection sensor 23 can be regarded as detecting a particular opening 80 of a particular opening row 81 (for example, the opening row 81a) of each opening group 82. As described above, the storage 28 stores the position information of all openings 80 of the first conveyance belt 8 in advance.

In the structure in which the printer 100 includes such a first conveyance belt 8 and an opening detection sensor 23, the discharge control portion 110a may perform the following control process. Specifically, in accordance with the position information of each opening 80 set in advance, the detection result of the opening 80 of the particular opening row 81a detected by the opening detection sensor 23, and the detection result of the paper P detected by the opening detection sensor 23, the discharge control portion 110a may determine whether there are the openings 80 that overlap with the paper P in the other opening row 81b of the opening group 82 to which the particular opening row 81a belongs and, in accordance with the determination result, identify the flushing executable timing for the openings 80 of the other opening row 81b.

For example, when it is determined that no paper P overlaps the other opening row 81b, the discharge control portion 110a may identify the ink discharge timing for the openings 80 of the other opening row 81b as the flushing executable timing. When it is determined that the paper P completely overlaps the openings 80 of the other opening row 81b, the discharge control portion 110a may exclude the ink discharge timing for the openings 80 of the other opening row 81b from the flushing executable timing. When it is determined that the paper P overlaps part of the openings 80 of the other opening row 81b, the discharge control portion 110a may identify the ink discharge timing for the remaining area of the opening row 81b (area that is not overlapped by the paper P) as the flushing executable timing.

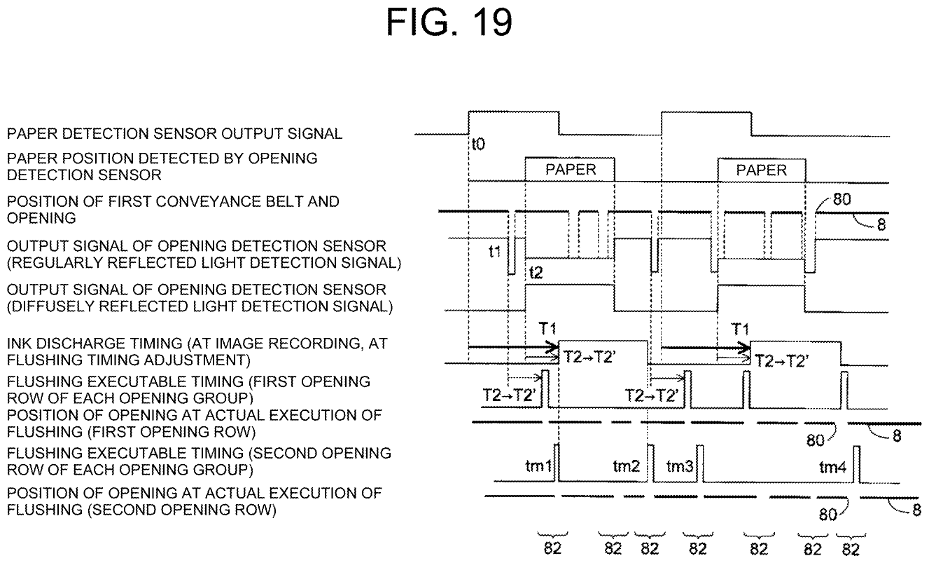

FIG. 19 is a timing chart illustrating the output signals of the various sensors and the relationship between the positions of the openings 80 of two opening rows 81a (first opening row) and 81b (second opening row), both of which belong to the opening group 82, and the flushing executable timing. In the example illustrated in the chart, of the opening row 81b of the opening group 82, the discharge control portion 110a identifies the ink discharge timing for the openings 80 of the opening row 81b of the opening group 82 that are not overlapped by the paper P (or the paper P is shifted in the conveyance direction) as the flushing executable timing (see tm3, tm4). When the paper P overlaps part of the openings 80 of the opening row 81b, the discharge control portion 110a identifies the ink discharge timing to discharge ink for the remaining area other than the part of the openings 80 as the flushing executable timing (see tm1, tm2).

In the first conveyance belt 8 in which the openings 80 are arranged in the staggered manner and the opening detection sensor 23 detects the openings 80 of the particular opening row 81a, even when the opening detection sensor 23 does not detect the openings 80 of the other opening row 81b, the discharge control portion 110a can determine whether the paper P is placed on top of the openings 80 of the other opening row 81b, in accordance with the position information of each opening 80, the detection result of the openings 80 in the particular opening row 81a, and the detection result of the paper P. Therefore, by setting the flushing executable timing in accordance with the determination result, the discharge control portion 110a can execute the flushing appropriately for the openings 80 of the other opening row 81b even though the opening detection sensor 23 does not detect the openings 80.

When it is determined that the paper P is shifted from the openings 80 of the other opening row 81b as described above, the discharge control portion 110a identifies the ink discharge timing for the openings 80 as the flushing executable timing. In this case, the discharge control portion 110a can perform the flushing for the openings 80 of the opening row 81b by causing the recording heads 17a to 17c to discharge ink at the identified flushing executable timing.

When it is determined that the paper P overlaps part of the openings 80 of the other opening row 81b, the discharge control portion 110a identifies the ink discharge timing for the remaining area of the openings 80 as the flushing executable timing. In this case, the discharge control portion 110a can perform the flushing for the area of the openings 80 of the opening row 81b where the paper P does not overlap by causing the recording heads 17a to 17c to discharge ink at the identified flushing executable timing. The discharge control portion 110a can determine whether the flushing is actually performed at the identified flushing executable timing.

When it is determined that there are the openings 80 of the opening row 81b that overlap with the paper P, it is desirable that the discharge control portion 110a stops the ink discharge from the recording heads 17a to 17c for the openings 80. In other words, it is desirable that the discharge control portion 110a excludes such an ink discharge timing for the openings 80 from the flushing executable timing. In this case, the ink is not discharged onto the paper P placed on top of the openings 80 during flushing according to the flushing executable timing, so that the possibility of soiling the paper P with ink can be avoided.

When a length of the remaining area of the openings 80 (area that does not overlap with the paper P) in the paper conveyance direction is equal to or smaller than a predetermined value (for example, several millimeters) due to the paper P overlapping part of the openings 80, the execution of flushing for the remaining area of the openings 80 may cause soiling of the paper P by the ink proceeding to the area other than the remaining area of the openings 80 and landing on and soiling the paper P due to variations of an ink discharge angle of the ink discharged during flushing.

Therefore, it is desirable that the discharge control portion 110a stops the ink discharge toward the openings 80. In other words, when it is determined that the paper P overlaps part of the openings 80 of the opening row 81b and the length of the remaining area of the openings 80 in the paper conveyance direction is equal to or smaller than the predetermined value, the discharge control portion 110a desirably stops the ink discharge by the recording heads 17a to 17c for the openings 80. This avoids the possibility of soiling the paper P due to the variations in the ink discharge angle when executing the flushing for the openings 80 (especially for the remaining area that does not overlap the paper P).

Even when the paper P is separated from the openings 80 of each opening group 82 (opening row 81a, opening row 81b) on the first conveyance belt 8, if the conveyance of the paper P is delayed, for example, for some reason and the separation distance is equal to or smaller than the predetermined distance (for example, several millimeters), if flushing is performed on the above-mentioned openings 80, a risk of causing soiling the paper P with the ink proceeding in the direction other than the direction of the openings 80 and landing on and soiling the nearby paper P due to variations in the discharge angle of the ink discharged during the flushing.

Therefore, it is desirable that the discharge control portion 110a calculates the separation distance between the openings 80 and the paper P in the paper conveyance direction in accordance with the detection results of the openings 80 and the paper P by the opening detection sensor 23, and stops the ink discharge from the recording heads 17a to 17c for the openings 80 when the separation distance is equal to or smaller than the predetermined distance. This avoids the possibility of soiling the paper P that is placed near the openings 80 due to the variations of the ink discharge angle during the flushing for the openings 80.

In the above description, one opening detection sensor 23 is used to detect one opening 80 in the particular opening row 81a. In addition, another opening detection sensor that detects the openings 80 of the other opening row 81b may also be provided. Then, such an opening detection sensor detects the paper P, and the discharge control portion 110a may identify the flushing executable timing for the openings 80 of the other opening row 81b in accordance with the detection results of the openings 80 of the other opening row 81b and the paper P by the opening detection sensor.

As described above, the printer 100 that functions as the inkjet recording device according to the present embodiment includes the opening detection sensor 23 that detects both regularly reflected light and diffusely reflected light. In this case, as described above, the discharge control portion 110a can recognize the first conveyance belt 8, the openings 80, and the paper P separately in accordance with the output signal from the opening detection sensor 23. Therefore, in the factory settings of the printer 100, the flushing timing adjustment method described above can be carried out in accordance with the output results of the opening detection sensor 23. After shipment from the factory, the flushing control described above can be performed by the discharge control portion 110a in accordance with the output results of the opening detection sensor 23. In other words, the opening detection sensor 23 used for the flushing timing adjustment in the factory settings can also be effectively used to control the flushing after shipment from the factory.

### 8. Others

In the above, the case where the paper P is suctioned onto and conveyed on the first conveyance belt 8 by the negative-pressure suction has been described. Alternatively, the first conveyance belt 8 may electrically be charged, and the paper P is electrostatically suctioned onto and conveyed on the first conveyance belt 8 (electrostatic suctioning).

In the above, the case where the color printer that records color images using four-color inks has been described as an example of the inkjet recording device has been described. Alternatively, the flushing timing adjustment method and the flushing control are applicable to the case where a monochrome printer that records monochrome images with black ink is used.

### INDUSTRIAL APPLICABILITY

The invention is applicable to inkjet printers and other inkjet recording devices.

### DESCRIPTION OF REFERENCE NUMERALS

8 First conveyance belt
13 Registration roller pair (recording medium supply portion)
17a to 17c Recording head
18 Ink discharge port (nozzle)
22 Paper detection sensor (recording medium detection sensor)
23 Opening detection sensor
27 Operation panel (input accepting portion)
29 Communication portion (input accepting portion)
30 Input accepting portion
80 Opening
81, 81a, 81b Opening row
82, 82A to 82F Opening group
100 Printer (inkjet recording device)
110a Discharge control portion
C1 First chart
C2 Second chart
Cr1 First reference line
Cr2 Second reference line
Cs1 First auxiliary line
Cs2 Second auxiliary line
P Paper (recording medium)

1. A flushing timing adjustment method of an inkjet recording device for adjusting a flushing timing which is an ink discharge timing for flushing to discharge ink from a recording head toward openings of an endless conveyance belt, comprising:
detecting a recording medium supplied from a recording medium supply portion to the conveyance belt by a recording medium detection sensor;
detecting the recording medium conveyed by the conveyance belt by an opening detection sensor that detects the openings that move by running of the conveyance belt;
recording a first chart on the recording medium by discharging ink from a predetermined nozzle of the recording head at a plurality of discharge timings set in advance using a detection time point at which the recording medium is detected by the recording medium detection sensor as a reference time point, and recording a second chart on the recording medium alongside the first chart by discharging ink from another nozzle of the recording head at a plurality of discharge timings set in advance using a detection time point at which the recording medium is detected by the opening detection sensor as a reference time point; and
adjusting the flushing timing in accordance with the an input of an instruction following the recording of the first chart and the second chart on the recording medium, the flushing timing being set using the detection time point at which the opening is detected by the opening detection sensor as a reference time point.

2. The flush timing adjustment method according to claim 1, wherein
the adjusting the flushing timing includes adjusting the flushing timing in accordance with an adjustment value entered following the recording of the first chart and the second chart on the recording medium.

3. The flush timing adjustment method according to claim 1, wherein
the first chart includes a first reference line formed by the ink discharged at a reference discharge timing from the predetermined nozzle of the recording head in accordance with the detection of the recording medium by the recording medium detection sensor, and
the second chart includes a second reference line formed by the ink discharged at a reference discharge timing from the other nozzle of the recording head in accordance with the detection of the recording medium by the opening detection sensor.

4. The flush timing adjustment method according to claim 3, wherein
the first chart further includes a plurality of first auxiliary lines formed by the ink discharged from the predetermined nozzle at a plurality of timings before and after the reference discharge timing and arranged with the first reference line in a conveyance direction of the recording medium, and
the second chart further includes a plurality of second auxiliary lines formed by the ink discharged from the other nozzle at a plurality of timings before and after the reference discharge timing and arranged with the second reference line in the conveyance direction of the recording medium.

5. The flush timing adjustment method according to claim 4, wherein
an interval between all lines of the first chart in the conveyance direction of the recording medium is different from an interval between all lines of the second chart in the conveyance direction of the recording medium.

6. The flush timing adjustment method according to claim 4, wherein
the interval between all lines of the first chart in the conveyance direction of the recording medium is identical to the interval between all lines of the second chart in the conveyance direction of the recording medium,
all the lines of the first chart have mutually different line widths,
all the lines of the second chart have mutually different line widths, and
the first chart includes lines each having a line width identical to a line width of lines of the second chart.

7. The flush timing adjustment method according to claim 1, wherein
the opening detection sensor is an optical sensor that detects both regularly diffused light and diffusely reflected light.

8. An ink jet recording device, comprising:
a recording head having a plurality of nozzles for discharging ink;
an endless conveyance belt that conveys a recording medium and has openings at a plurality of locations in the conveyance direction of the recording medium, the openings allowing ink to pass through when the recording head executes flushing for discharging the ink at timing different from timing that contributes to image formation;
a recording medium supply portion that supplies the recording medium to the conveyance belt;
a recording medium detection sensor that detects the recording medium supplied from the recording medium supply portion to the conveyance belt;
an opening detection sensor that detects the openings that move by running of the conveyance belt, and also detects the recording medium on the conveyance belt; and
a discharge control portion that controls the ink discharge from the recording head, wherein
the discharge control portion causes a first chart to be recorded on the recording medium by discharging ink from a predetermined nozzle of the recording head at a plurality of discharge timings set in advance using a detection time point at which the recording medium is detected by the recording medium detection sensor as a reference time point, and causes a second chart to be recorded on the recording medium alongside the first chart by discharging ink from another nozzle of the recording head at a plurality of discharge timings set in advance using a detection time point at which the recording medium is detected by the opening detection sensor as a reference time point.

9. The ink jet recording device according to claim 8, further comprising:
an input accepting portion that accepts an instruction input for adjusting the flushing timing which indicates timing when the recording head discharges ink when executing the flushing, wherein
the discharge control portion adjusts the flushing timing set by using the detection time point of the opening by the opening detection sensor as a reference time point in accordance with the instruction input accepted by the input accepting portion.

10. The ink jet recording device according to claim 8, wherein
the discharge control portion identifies a flushing executable timing in accordance with detection results of the opening and the recording medium by the opening detection sensor, and
the flushing executable timing is the discharge timing of the ink that enables the ink discharged from the recording head to pass through at least part of the openings during the execution of the flushing among the openings at the plurality of locations.

11. The ink jet recording device according to claim 10, wherein
when a plurality of the flushing executable timings are identified, the discharge control portion causes the recording head to execute the flushing at least at a timing of the plurality of the identified flushing executable timings.

12. The ink jet recording device according to claim 11, wherein
the discharge control portion determines a usage state of each nozzle of the recording head in accordance with image data of an image to be recorded on the recording medium, selects timing to actually discharge the ink from the recording head from among the plurality of flushing executable timings in accordance with the determination result, and causes the recording head to execute the flushing at the selected timing.

13. The ink jet recording device according to claim 10, wherein
the conveyance belt has opening groups at a plurality of locations,
each of the opening groups includes a plurality of opening rows in the conveyance direction of the recording medium, each of the opening row having the openings arranged in a belt width direction perpendicular to the conveyance direction,
the openings of each opening row of each opening group are shifted from the openings of an adjacent opening row in the belt width direction in a manner that the openings of the opening row overlap part of the openings of the adjacent opening row when viewed in the conveyance direction,
the opening detection sensor detects a particular opening of a particular opening row of each opening group,
the discharge control portion determines whether there is an opening that overlaps with the recording medium in an other opening row of the opening group to which the particular opening row belongs, in accordance with position information of the each opening set in advance, a detection result of the opening of the particular opening row detected by the opening detection sensor, and a detection result of the recording medium detected by the opening detection sensor, and identifies the flushing executable timing for the opening of the other opening row in accordance with the determination result.

14. The ink jet recording device according to claim 13, wherein
when it is determined that the recording medium is shifted from the openings of the other opening row in the conveyance direction, the discharge control portion identifies the ink discharge timing for the openings as the flushing executable timing.

15. The ink jet recording device according to claim 13, wherein
when it is determined that the recording medium overlaps a part of the openings of the other opening row, the discharge control portion identifies the ink discharge timing for a remaining area of the openings as the flushing executable timing.

16. The ink jet recording device according to claim 15, wherein
when it is determined that the recording medium overlaps the part of the openings of the other opening row and a length of the remaining area of the openings in the conveyance direction is equal to or smaller than a predetermined value, the discharge control portion stops discharging of the ink to the openings from the recording head.

17. The ink jet recording device according to claim 10, wherein
the discharge control portion determines a separation distance between the openings and the recording medium in the conveyance direction in accordance with the detection results of the openings and the recording medium by the opening detection sensor and, when it is determined that the separation distance is equal to or smaller than a predetermined distance, stops the discharging of the ink to the openings from the recording head.

18. The ink jet recording device according to claim 8, wherein
the opening detection sensor is an optical sensor that detects both regularly reflected light and diffusely reflected light.
